(19) United States
(12) Patent Application Publication
(10) Pub. No.: US 2014/0075094 A1
(43) Pub. Date: Mar. 13, 2014

(54) METHOD TO IMPLEMENT A BINARY FLAG IN FLASH MEMORY

(71) Applicants: Ansaf I. Alrabady, Livonia, MI (US); Kevin M. Baltes, Wixom, MI (US); Thomas M. Forest, Macomb, MI (US)

(72) Inventors: Ansaf I. Alrabady, Livonia, MI (US); Kevin M. Baltes, Wixom, MI (US); Thomas M. Forest, Macomb, MI (US)

(73) Assignee: GM GLOBAL TECHNOLOGY OPERATIONS LLC, Detroit, MI (US)

(21) Appl. No.: 13/612,272

(22) Filed: Sep. 12, 2012

(51) Int. Cl. G06F 12/02

(52) U.S. Cl. 711/103; 711/E12.008

(57) ABSTRACT

A system and method for changing a state of a binary flag in a flash memory. The method defines a cell segment including a predetermined number of bits as the binary flag, where each bit is converted to a logical 1 when the memory is erased. The method also defines that an even number of logical 1 bits in the flash cell segment is an even parity and an odd number of logical 1 bits in the flash cell segment is an odd parity, and defines whether an even parity is an ON state of the binary flag or an odd parity is the ON state of the binary flag. The method changes the parity of the binary flag by writing one of the bits in the flash cell segment from a logical 1 to a logical 0 to change the state of the flag.

### BACKGROUND OF THE INVENTION

1. Field of the Invention

This invention relates generally to a system and method for using a memory cell segment in an ECU flash memory to implement a binary flag and, more particularly, to a system and method for using a memory cell segment in the flash memory of an ECU to implement a binary flag that includes flipping one of the bits in the cell segment from a logical 1 to a logical 0 to change the parity of the bits and the state of the flag.

2. Discussion of the Related Art

Most modern vehicles include electronic control units (ECUs), or controllers, that control the operation of vehicle systems, such as the powertrain, climate control system, infotainment system, body systems, chassis systems, and others. Such controllers require special purpose-designed software in order to perform the control functions. Flashing is a well-known process for uploading software, calibration files and other applications into a flash memory of a vehicle ECU or other programmable device. A bootloader is an embedded software program loaded on the ECU that provides an interface between the ECU and a programming device that is flashing the software.

It is usually necessary to provide binary flags in software code that indicates a particular state of some operation, where the flag is a bit or series of bits that can be switched between an ON state and an OFF state. An EEPROM or an EEPROM emulated flash memory is one known non-volatile memory (NVM) suitable to provide a binary flag, where bits in the NVM can be written too and be separately erased, and where the bits will be maintained when the NVM is powered down. However, an EEPROM is often undesirable as a memory because of the extra hardware cost and it is often difficult to operate at high temperatures. Similarly, an EEPROM emulated flash memory is also undesirable to use within the boot area because the write operation requires additional drivers of 10-25K of the space-limited boot ROM.

The flash memory referred to above is also a non-volatile memory that is suitable to provide binary flags. Flash memory has the advantages that it is less expensive, takes less memory space for certain data, operates better at higher temperatures, etc. However, flash memory has the drawback that when writing to the memory, the programming must be done in relatively large blocks, where single bits cannot be separately written too. For example, flash memory requires writing in memory segments of 4 kilobytes, 8 kilobytes, 16 kilobytes, etc. Thus, if the state of a flag needs to be changed in the flash memory, much of the memory may need to be rewritten. Further, when a section of the flash memory is erased, all the bits in that section are converted to logical 1s. Thus, it is possible to write one of the bits in an erased segment of the flash from a logical 1 to a logical 0, but it is not possible to separately write that bit back to a logical 1 independent of the other bits in the segment without erasing all of the other bits in that memory block. It is possible to use a whole memory writable segment, such as a kilobyte block, as a single flag, however, this is not an efficient use of the memory space and it generally would be desirable to provide more data in that memory block than just the flag.

### SUMMARY OF THE INVENTION

In accordance with the teachings of the present invention, a system and method are disclosed for changing a state of a binary flag in a flash memory, where the flash memory includes memory sections having bits where the bits can only separately be changed from a logical 1 to a logical 0 without erasing the entire memory section. The method defines a cell segment in the flash memory section including a predetermined number of bits, such as 8 bits, as the binary flag, where each bit is converted to a logical 1 when the memory section is erased. The method also defines that an even number of logical 1 bits in the flash cell segment is an even parity and an odd number of logical 1 bits in the flash cell segment is an odd parity, and defines whether an even parity is an ON state of the binary flag or an odd parity is the ON state of the binary flag or whether an even parity is an OFF state of the binary flag or an odd parity is the OFF state of the binary flag. The method changes the parity of the binary flag by writing one of the bits in the flash cell segment from a logical 1 to a logical 0 to change the state of the flag.

Additional features of the present invention will become apparent from the following description and appended claims, taken in conjunction with the accompanying drawings.

### BRIEF DESCRIPTION OF THE DRAWINGS

FIG. 1 is an illustration of an electronic control unit;

FIG. 2 is a flow chart diagram showing a process for determining a parity state of a cell in a flash memory; and

FIG. 3 is a flow chart diagram showing a process for switching the state of a flag without erasing the flag section.

### DETAILED DESCRIPTION OF THE EMBODIMENTS

The following discussion of the embodiments of the invention directed to a system and method for switching the state of a binary flag in a flash memory of a controller is merely exemplary in nature, and is in no way intended to limit the invention or its applications or uses. For example, the system and method of the invention has particular application for changing the state of a binary flag in the flash memory of a vehicle ECU. However, as will be appreciated by those skilled in the art, the system and method may have application for other controllers.

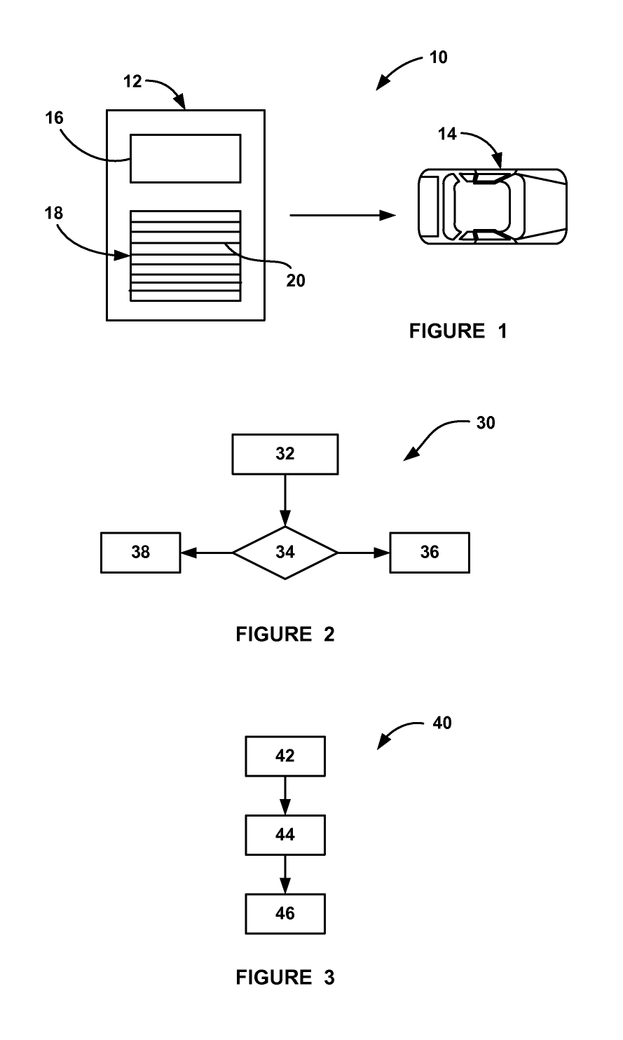

FIG. 1 is an illustration 10 showing an ECU 12 that can be one of many ECUs on a vehicle 14. The ECU 12 includes a CPU 16 that operates the ECU 12 and a flash memory 18 including a number of memory sections 20. As discussed herein, the memory sections 20 are those sections, such as 4 kilobytes, 8 kilobytes, 12, kilobytes, etc., within the flash memory 18 that have bits that cannot be separately erased, where the entire section 20 needs to be erased to erase one bit. The illustration 10 is intended to be a general illustration without limitation to the type of vehicle, the type of the ECU 12, the size of the flash memory 18, the purpose of the ECU 12, the power of the CPU 16, the number of CPUs 16 in the ECU 12, or any other limitation for the discussion herein.

The present invention proposes a technique for using a memory cell segment in the flash memory of an ECU to implement a binary flag without having to erase an entire flash memory section to change the state of the flag. Table 1 below illustrates this technique for implementing a binary flag in a memory cell segment of the flash memory. In the left column, each row represents a flash cell segment that is one byte long and includes 8 bits as a non-limiting example. This flash cell segment will be part of a larger flash memory section that must be erased as a unit, where all of the bits in that section would be converted to logical 1s when the section is erased. In this example, the flash cell segment representing the binary flag has initially been erased to include the 8 logical 1 bits and is given a parity that is a representation of how many bits in the byte are a logical 1 as being even or odd. For the first state of the binary flag where all of the bits are a logical 1 and the parity is even, the binary flag is designated as being set or in the ON state. Alternately, for a parity of odd where the number of logical 1 bits are an odd number, the binary state can be designated as being not set or in the OFF state.

As mentioned above, for a flash memory, individual bits can be written from a logical 1 to a logical 0, but cannot be written from a logical 0 to a logical 1 without being erased first. The present invention overcomes the limitation in the flash memory for establishing a binary flag by using the parity of the number of logical 1 bits in the flash cell segment as the indication of whether the flag is in the ON state or the OFF state. As shown in Table 1, each time the state of the binary flag has to be changed from the ON state to the OFF state, or vice-versa, one of the bits is written to a logical 0 to change the parity of the number of bits so that the state of the binary flag changes. In the example shown in Table 1, a logical shift left is performed each time the state of the binary flag is changed, where a logical 0 is shifted from the right into the right most location of the byte as shown in the second row of Table 1. This changes the parity of the logical 1 bits, which changes the binary state of the binary flag to the OFF state as shown in the third column. If the binary flag needs to be changed back to the ON state, a logical shift left is performed again as shown in the third row so that the parity is now even, which indicates that the binary state is in the ON state. This process can continue until all of the bits are written to a logical 0 as shown in the last row, which is a parity of even with the binary state ON. After all of the bits are a logical 0, then the entire flash memory segment needs to be erased to reset the binary flag. Therefore, the number of bits in the flash cell is selected based on how often the state of the binary flag will be changed before the flash memory segment is entirely erased to convert the bits back to logical 1s.

If it is desirable for the erased state of the flash memory segment to indicate that the state of the binary flag is the OFF state, where all the bits are a logical 1, then the parity of even will be the OFF state. Further, if it is desirable to make the final state of the binary flag different than the initial state, it would be necessary to have an odd number of bits in the flash cell segment. For example, the number of bits in the flash cell segment can include an even number of bits if it is desirable to have a final flag state the same as an initial flag state and an odd number of bits if it is desirable to have a final flag state different than the initial flag state. Further, it is not necessary to only flip one bit from a logical 1 to a logical 0 each time the state of the binary flag is changed, but the logical shift can be performed to put any number of logical 0s into the flash cell segment to change the state of the binary flag if it is desirable, for example, to make that group of bits more permanent. In other words, it may be desirable to disable the binary flag from further state changes by setting all of the bits in the cell segment to logical 0s. It is noted that this application is for those binary flags that are typically not flipped between states very often, i.e., are not run time binary flags.

TABLE 1

| Flash Cell | Parity (Cell) | Binary State |
|---|---|---|
| 11111111 | Even | ON |
| 11111110 | Odd | OFF |
| 11111100 | Even | ON |
| 11111000 | Odd | OFF |
| 11110000 | Even | ON |
| 11100000 | Odd | OFF |
| 11000000 | Even | ON |
| 10000000 | Odd | OFF |
| 00000000 | Even | ON |

FIG. 2 is a flow chart diagram 30 showing a process for determining the state of the binary flag in the flash memory cell segment as discussed above. At box 32, the algorithm reads the flash cell segment from the flash memory and at decision diamond 34 determines the parity of the bits in the flash cell segment. If the parity is even, then the algorithm determines that the state of the binary flag is the ON state at box 36 and if the parity is odd, the algorithm determines that the state of the binary flag is the OFF state at box 38. As mentioned above, this logical state can be switched where an even parity is the OFF state and an odd parity is the ON state.

FIG. 3 is a flow chart diagram 40 showing a process for how the algorithm switches the state of the binary flag as discussed above. At box 42, the algorithm reads the flash cell segment from the flash memory and at box 44 performs a logical shift left to change the right most logical 1 bit in the flash cell segment from a logical 1 to a logical 0. As mentioned above, a logical shift right can be performed instead of a logical shift left to obtain the same results. At box 46, the algorithm writes the flash cell segment back to the flash memory to change the state of the flag.

As will be well understood by those skilled in the art, the several and various steps and processes discussed herein to describe the invention may be referring to operations performed by a computer, a processor or other electronic calculating device that manipulate and/or transform data using electrical phenomenon. Those computers and electronic devices may employ various volatile and/or non-volatile memories including non-transitory computer-readable medium with an executable program stored thereon including various code or executable instructions able to be performed by the computer or processor, where the memory and/or computer-readable medium may include all forms and types of memory and other computer-readable media.

The foregoing discussion disclosed and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for changing a state of a binary flag in a flash memory where the flash memory includes memory sections having bits where the bits can only separately be changed from a logical 1 to a logical 0 without erasing the entire memory section, said method comprising:
defining a cell segment in the flash memory section including a predetermined number of bits as the binary flag where each bit is converted to a logical 1 when the memory section is erased;
defining that an even number of logical 1 bits in the flash cell segment is an even parity and an odd number of logical 1 bits in the flash cell segment is an odd parity;
defining whether an even parity is an ON state of the binary flag or an odd parity is an ON state of the binary flag; and
changing the parity of the binary flag by writing one of the bits in the binary flag from a logical 1 to a logical 0 to change the state of the flag.

2. The method according to claim 1 wherein changing one of the bits in the flash cell segment from a logical 1 bit to a logical 0 bit includes performing a logical shift left.

3. The method according to claim 1 wherein changing one of the bits in the flash cell segment from a logical 1 bit to a logical 0 bit includes performing a logical shift right.

4. The method according to claim 1 wherein defining a flash cell segment including a predetermined number of bits includes defining the flash cell segment to include an even number of bits if it is desirable to have a final flag state the same as an initial flag state and an odd number of bits if it is desirable to have a final flag state different than the initial flag state.

5. The method according to claim 1 further comprising disabling the binary flag from further state changes by setting all of the bits in the cell segment to logical 0s.

6. The method according to claim 1 wherein the flash memory is a memory in an electronic control unit (ECU) on a vehicle.

7. A method for changing a state of a binary flag in a flash memory in an electronic control unit (ECU) on a vehicle, where the flash memory includes memory sections having bits where the bits can only separately be changed from a logical 1 to a logical 0 without erasing the entire memory section, said method comprising:
defining a flash cell segment in the memory section including a predetermined number of bits as the binary flag;
defining that an even number of logical 1 bits in the flash cell segment is an even parity and an odd number of logical 1 bits in the flash cell segment is an odd parity;
defining whether an even parity is an ON state of the binary flag or an odd parity is an ON state of the binary flag; and
changing the parity of the binary flag by writing one of the bits in the binary flag from a logical 1 to a logical 0 to change the state of the flag.

8. The method according to claim 7 wherein changing one of the bits in the flash cell segment from a logical 1 bit to a logical 0 bit includes performing a logical shift left.

9. The method according to claim 7 wherein changing one of the bits in the flash cell segment from a logical 1 bit to a logical 0 bit includes performing a logical shift right.

10. The method according to claim 7 wherein defining a flash cell segment including a predetermined number of bits includes defining the flash cell segment to include an even number of bits if it is desirable to have a final flag state the same as an initial flag state and an odd number of bits if it is desirable to have a final flag state different than the initial flag state.

11. The method according to claim 7 further comprising disabling the binary flag from further state changes by setting all of the bits in the cell segment to logical 0s.

12. A system for changing a state of a binary flag in a flash memory where the flash memory includes memory sections having bits where the bits can only separately be changed from a logical 1 to a logical 0 without erasing the entire memory section, said system comprising:
means for defining a flash cell segment in the memory section including a predetermined number of bits as the binary flag where each bit is converted to a logical 1 when the memory section is erased;
means for defining that an even number of logical 1 bits in the flash cell segment is an even parity and an odd number of logical 1 bits in the flash cell segment is an odd parity;
means for defining whether an even parity is an ON state of the binary flag or an odd parity is an ON state of the binary flag; and
means for changing the state of the binary flag by writing one of the bits in the flash cell segment from a logical 1 to a logical 0 to change the parity and the state of the flag.

13. The system according to claim 12 wherein the means for changing one of the bits in the flash cell segment from a logical 1 bit to a logical 0 bit performs a logical shift left.

14. The system according to claim 12 wherein the means for changing one of the bits in the flash cell segment from a logical 1 bit to a logical 0 bit performs a logical shift right.

15. The system according to claim 12 wherein the means for defining a flash cell segment including a predetermined number of bits defines the flash cell segment to include an even number of bits if it is desirable to have a final flag state the same as an initial flag state and an odd number of bits if it is desirable to have a final flag state different than the initial flag state.

16. The system according to claim 12 further comprising means for disabling the binary flag from further state changes by setting all of the bits in the cell segment to logical 0s.

17. The system according to claim 12 wherein the flash memory is a memory in an electronic control unit (ECU) on a vehicle.
